(19) United States
(12) Patent Application Publication
(10) Pub. No.: US 2023/0012034 A1
(43) Pub. Date: Jan. 12, 2023

(54) APPARATUS, METHOD, AND COMPUTER PROGRAM FOR PERFORMING SPH-BASED FLUID ANALYSIS SIMULATION

(71) Applicant: E8IGHT CO., LTD, Seongnam-si Gyeonggi-do (KR)

(72) Inventors: Sang Min SONG, Yongin-si Gyeonggi-do (KR); Eun Su KIM, Seongnam-si Gyeonggi-do (KR); Si Woo LEE, Seoul (KR)

(73) Assignee: E8IGHT CO., LTD, Seongnam-si Gyeonggi-do (KR)

(21) Appl. No.: 17/784,665

(22) PCT Filed: Dec. 27, 2019
(86) PCT No.: PCT/KR2019/018582

§ 371 Date: Jun. 12, 2022

(30) Foreign Application Priority Data
Dec. 13, 2019 (KR) 10-2019-0166619

(51) Int. Cl. G06F 30/28

(52) U.S. Cl. CPC G06F 30/28; G06F 2113/08

(57) ABSTRACT

A smoothed-particle hydrodynamics (SPH)-based fluid analysis simulation apparatus comprises: an input unit for receiving, as an input, data about a plurality of particles, for a fluid analysis simulation; a space formation unit that divides, into a plurality of cells, the space in which the plurality of particles are present, and generates cell indexes on the basis of the locations of the cells in the space where the plurality of particles are present; a particle search unit for searching for at least one neighboring particle that neighbors a target particle, on the basis of particle reference information about the plurality of particles and cell reference information about the plurality of cells; and a flow data calculation unit that calculates flow data between the target particle and the at least one neighboring particle, and performs a fluid simulation on the basis of the flow data for the plurality of particles.

### TECHNICAL FIELD

The present invention relates to an apparatus, a method, and a computer program for performing a smoothed particle hydrodynamics (SPH)-based fluid analysis simulation.

### BACKGROUND ART

Computational fluid dynamics (CFD) as a field of fluid dynamics calculates a dynamic motion of a fluid using a computer in a numerical analytical method. The CFD calculates the flow of the fluid by discretizing a Naiver-Stokes Equation which is a partial differential equation through methods such as Finite Difference Method (FDM), Finite Element Method (FEM), Finite Volume Method (FVM), and Smoothed Particle Hydrodynamics (SPH).

There are two methods for calculating the Navier-Stokes equation: a lattice-based method that discretizes a spatial domain into a small mesh or lattice, and a particle-based method that expresses a fluid as a set of multiple particles.

In the particle-based method, a more natural simulation of natural or physical phenomena is possible by expressing an analysis target as particles instead of using a lattice. The particle-based method includes Smoothed Particle Hydrodynamics (SPH), Moving Particle Semi-implicit (MPS), Lattice Boltzmann Method (LBM), etc.

A Smoothed Particle Hydrodynamics (SPH)-based fluid analysis, which is one of the particle-based methods, can simulate the results of the analysis relatively quickly because the step of generating the grid is omitted, unlike the grid-based method.

In addition, since the SPH-based fluid analysis performs the analysis by using particles without generating the grid, analysis of free surfaces such as liquid-gas interfaces can be performed relatively easily.

Further, the SPH-based fluid analysis can perform relatively accurate analysis of multiphase flows including two or more of gas, liquid, and solid.

Due to the advantages, recently, SPH has been widely used in simulating the flow of the fluid.

However, in the case of simulation using a plurality of processors, in order to efficiently use each processor, a process of exchanging particle information between the plurality of processors is required.

Meanwhile, Korean Patent Registration No. 1700829 discloses a configuration for searching for neighboring particles of each particle on a cell-by-cell basis and a configuration for distributing cells to several computing devices.

### SUMMARY OF THE DISCLOSURE

An object of the present invention is to provide an apparatus, a method, and a computer program for performing a fluid analysis simulation capable of searching for neighboring particles.

Another object of the present invention is to provide an apparatus, a method, and a computer program for performing fluid analysis simulation using a plurality of processors.

However, a technical object to be achieved by the embodiment of the present invention is not limited to the above-mentioned technical objects and there may be other technical objects.

As a means for achieving the technical object, an embodiment of the present invention may provide a smoothed particle hydrodynamics (SPH)-based fluid analysis simulation apparatus, which includes: an input unit receiving data about a plurality of particles for a fluid analysis simulation, a space formation unit dividing, into a plurality of cells, the space in which the plurality of particles are present, and generating cell indexes based on the locations of the cells in the space where the plurality of particles are present, a particle search unit searching for at least one neighboring particle that neighbors a target particle, based on particle reference information about the plurality of particles and cell reference information about the plurality of cells, and a flow data calculation unit calculating flow data between the target particle and the at least one neighboring particle, and performing a fluid simulation based on the flow data for the plurality of particles.

In an embodiment, the particle search unit may include a particle information generation unit generating the particle reference information based on location information of the plurality of particles and the cell indexes and a cell information generation unit generating the cell reference information including the cell indexes and inclusion information generated based on the number of particles included in a cell corresponding to each cell index.

In an embodiment, the cell reference information may further include accumulation information generated based on the number of particles included in a cell corresponding to a cell index before each cell index.

In an embodiment, the particle information generation unit may sort the particle reference information in ascending order based on the cell index.

In an embodiment, the particle search unit may search for a neighboring cell based on a cell index corresponding to a cell in which the target particle is located, and search for the neighboring particle based on the inclusion information and the accumulation information corresponding to the neighboring cell included in the cell reference information.

In an embodiment, the particle search unit may track a first memory location of the particle reference information corresponding to the neighboring particle based on the accumulation information corresponding to the neighboring cell.

In an embodiment, the particle search unit may track a plurality of second memory locations of the particle reference information corresponding to the neighboring particle based on the inclusion information corresponding to the neighboring cell.

Another embodiment of the present invention may provide a smoothed-particle hydrodynamics (SPH)-based fluid analysis simulation method including receiving data about a plurality of particles for a fluid analysis simulation, dividing, into a plurality of cells, a space in which the plurality of particles are present, generating a cell index based on the location of the cell in the space in which the plurality of particles are present, searching for at least one neighboring particle that neighbors a target particle, based on particle reference information about the plurality of particles and cell reference information about the plurality of cells, calculating flow data between the target particle and the at least one neighboring particle, and performing a fluid simulation based on the flow data for the plurality of particles.

Another embodiment of the present invention may provide computer program stored in a medium including a sequence of instructions of performing a smoothed particle hydrodynamics (SPH)-based fluid analysis simulation, in which when the computer program is executed by a computing device, the computer program may include a sequence of instructions to receive data about a plurality of particles for a fluid analysis simulation, divide, into a plurality of cells, a space in which the plurality of particles are present, generate a cell index based on the location of the cell in the space in which the plurality of particles are present, search for at least one neighboring particle that neighbors a target particle, based on particle reference information about the plurality of particles and cell reference information about the plurality of cells, calculate flow data between the target particle and the at least one neighboring particle, and perform a fluid simulation based on the flow data for the plurality of particles.

The problem solving means is just exemplary, and should not be interpreted as an intention of limiting the present invention. In addition to the above-mentioned embodiment, an additional embodiment may exist, which is disclosed in drawings and a detailed description of the present disclosure.

According to any one of the above-mentioned technical solutions of the present invention, it is possible to provide an apparatus, a method, and a computer program for performing fluid analysis simulation capable of rapidly searching for neighboring particles and efficiently exchanging information between a plurality of processors.

In addition, it is possible to reduce the time required for performing the fluid analysis simulation for a complex structure, a wide space, and the like by using the plurality of processors.

In addition, it is possible to be applied to various technical fields by effectively predicting the movement of a fluid using a plurality of processors.

### BRIEF DESCRIPTION OF THE DRAWINGS

FIG. 1 is a block diagram of a fluid analysis simulation apparatus using a plurality of processors according to an embodiment of the present invention.

FIG. 2 is a block diagram of a fluid analysis simulation apparatus according to an embodiment of the present invention.

FIG. 3 exemplarily illustrates a process of generating particle reference information and cell reference information according to an embodiment of the present invention.

FIG. 4 is a diagram for describing a method of searching for a neighboring particle according to an embodiment of the present invention.

FIG. 5 exemplarily illustrates particle reference information and cell reference information generated by each of a plurality of processors according to an embodiment of the present invention.

FIG. 6 exemplarily illustrates a process of generating integrated cell reference information and integrated particle reference information according to an embodiment of the present invention.

FIG. 7 is a diagram for describing a process of exchanging particles with each other by a plurality of processors according to an embodiment of the present invention.

FIG. 8 is a diagram for describing a process of exchanging particles with each other by a plurality of processors according to an embodiment of the present invention.

FIG. 9 is a flowchart of a fluid analysis simulation method according to an embodiment of the present invention.

### DETAILED DESCRIPTION OF THE DISCLOSURE

Hereinafter, embodiments of the present invention will be described in detail so as to be easily implemented by those skilled in the art, with reference to the accompanying drawings. However, the present invention may be modified in various different ways, all without departing from the spirit or scope of the present invention. In addition, in the drawings, in order to clearly describe the present invention, a part not related to the description is omitted and like reference numerals designate like elements throughout the specification.

Throughout the specification, when it is described that a part is “connected” with another part, it means that the part may be “directly connected” with the other part and the parts may be “electrically or mechanically connected” to each other with still another element interposed therebetween. Further, when a part “includes” a component, it means that other components may be further included, rather than excluding other components, unless otherwise stated, and it is to be understood that the existence or addition of one or more other features, numbers, steps, operations, components, parts, or combinations thereof is not precluded in advance.

In this specification, a ‘unit’ includes a unit realized by hardware, a unit realized by software, and a unit realized using both. In addition, one unit may be implemented using two or more hardware, and two or more units may be implemented by one hardware. Meanwhile, ‘unit’ is not a meaning limited to the software or hardware and ‘unit’ may be configured to be positioned in a storage medium which is addressable or configured to reproduce one or more processors. Accordingly, as one example, the “unit” includes components such as software components, object oriented software components, class components, and task components, processes, functions, attributes, procedures, subroutines, segments of a program code, drivers, firmware, microcode, circuitry, data, databases, data structures, tables, arrays, and variables. Functions provided in the components and the ‘units’ may be combined into the smaller number of components and ‘units’ or further separated into additional components and ‘units’. Moreover, the components and the ‘units’ may be implemented to reproduce one or more CPUs in a device or a secure multimedia card.

Some of the operations or functions described as being performed by a terminal or device in this specification may be instead performed by a server connected to the terminal or device. Similarly, some of the operations or functions described as being performed by the server may also be performed in a terminal or device connected to the server.

Hereinafter, an embodiment of the present invention will be described in detail with reference to the accompanying drawings.

FIG. 1 is a block diagram of a fluid analysis simulation apparatus using a plurality of processors according to an embodiment of the present invention. FIG. 1 exemplarily illustrates a plurality of processors included in a fluid analysis simulation apparatus. Referring to FIG. 1, a fluid analysis simulation apparatus 100 may include a first processor 110, a second processor 120, and a third processor 130. However, the number of processors which may be included in the fluid analysis simulation apparatus 100 may include may be less or more than the case illustrated in FIG. 1.

The fluid analysis simulation apparatus 100 may include a server, a desktop, a notebook computer, a KIOSK, a smartphone, and a tablet PC. However, the fluid analysis simulation apparatus 100 is not limited to the exemplified apparatuses above. That is, the fluid analysis simulation apparatus 100 may include all devices equipped with a processor for performing an SPH-based fluid analysis simulation method to be described below.

The fluid analysis simulation apparatus 100 performs a three-dimensional flow analysis of the fluid. That is, the fluid analysis simulation apparatus 100 models a three-dimensional simulation region and a plurality of particles positioned in the three-dimensional simulation region, and analyzes the flow of the plurality of particles in the three-dimensional simulation region. However, in the present specification, for convenience of description, the simulation region and particles are expressed and described in two dimensions.

The fluid analysis simulation apparatus 100 may perform a simulation for analyzing a fluid based on smoothed particle hydrodynamics (SPH). The Smoothed Particle Hydrodynamics (SPH) is one of the particle-type fluid analysis techniques which may be used in Computational Fluid Dynamics (CFD). In order to simulate the motion of the fluid, the SPH may express a fluid to be analyzed as one or more particles. The SPH may calculate a physical quantity of each particle while tracking each particle, and perform the fluid analysis simulation based on the calculation result.

The first processor 110, the second processor 120, and the third processor 130 may each be an information processing device capable of performing an independent computing operation. One of the first processor 110, the second processor 120, and the third processor 130 may transmit information to the other or receive information from the other. In an embodiment, the first processor 110 and the second processor 120 may be a graphics processing unit (GPU), and the third processor 130 may be a central processing unit (CPU).

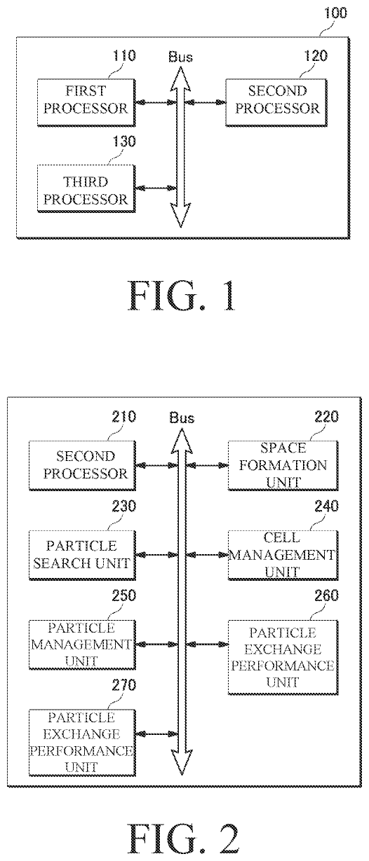

Referring to FIG. 2, the fluid analysis simulation apparatus 100 may include an input unit 210, a space formation unit 220, a particle search unit 230, a cell management unit 240, a particle management unit 250, a particle exchange performance unit 260 and a flow data calculation unit 270.

In one embodiment, each of the first processor 110 and the second processor 120 may include the space formation unit 220, the particle search unit 230, the particle exchange performance unit 260, and the flow data calculation unit 270, and the third processor 130 may include an input unit 210, the cell management unit 240, and the particle management unit 250. However, the configuration of each of the processors 110, 120, and 130 included in the fluid analysis simulation apparatus 100 is not limited thereto.

The input unit 210 may receive data about a plurality of particles for a fluid analysis simulation. For example, the input unit 210 may receive the data about the plurality of particles from an external device such as a user terminal.

The input unit 210 may also receive the data about the plurality of particles via communication with an external server. The data about the plurality of particles may include information on an object to be analyzed required to perform the fluid analysis simulation. The data about the plurality of particles may include information on physical properties of each particle, for example, at least one of a particle radius, a mass, a density, a viscosity, a velocity, an acceleration, and a position of each particle.

The fluid analysis simulation apparatus 100 may further include a modeling unit (not illustrated). The modeling unit may generate a structure model in which a plurality of particles are located. The modeling unit may generate, for example, a mesh-based structure model consisting of a plurality of polygons. The modeling unit may generate a plurality of particles based on a position (center coordinate) and a particle radius of each particle. The structure model may be generated, for example, based on a mesh consisting of a plurality of triangles.

The space formation unit 220 may divide, into a plurality of cells, a space in which the plurality of particles are present. The space formation unit 220 may generate cell indexes on the basis of the locations of the cells in the space where the plurality of particles are present.

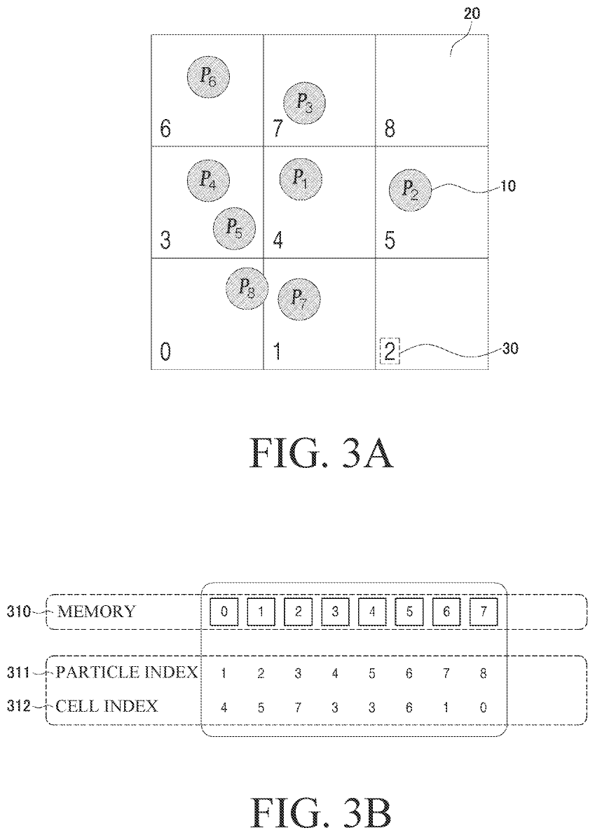

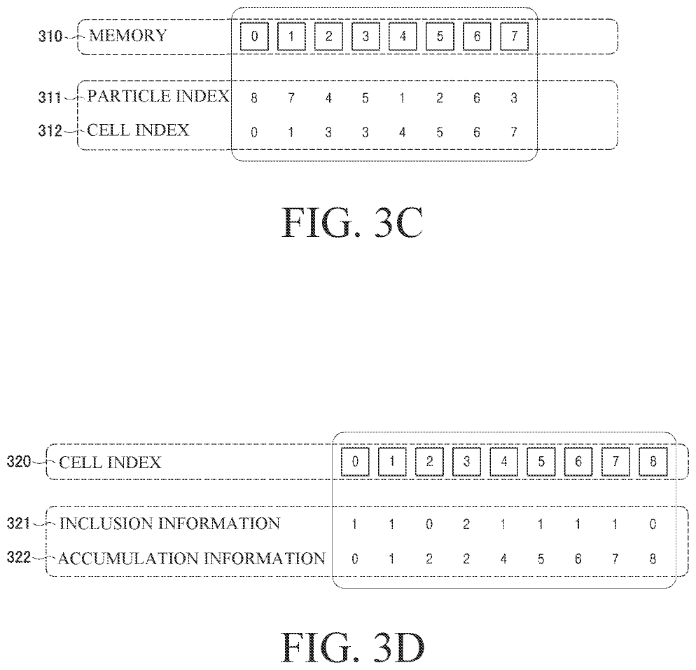

Referring to FIG. 3A, the space formation unit 220 may divide, into a plurality of cells 20, a space in which a plurality of particles 10 are present. The space formation unit 220 may determine the size of the cell 20 based on the radius of the particle 10. The space formation unit 220 may generate a cell index 30, which is a unique number assigned to each of the plurality of cells 20. For example, when the space where the plurality of particles 10 are present is divided into nine cells 20, one of numbers 0 to 8 is assigned sequentially to each cell 20 on the basis of the location of the cell 20 in the space to generate the cell index 30.

The space formation unit 220 may generate a particle index, which is a unique number assigned to each of a plurality of particles. Referring back to FIG. 3A, when data about eight particles 10 is received, the space formation unit 220 may assign, for example, one of numbers 0 to 7 sequentially to each particle 10 to generate a particle index.

In another embodiment, the particle index may be included in data about the plurality of particles received by the input unit 210.

The particle search unit 230 may search for at least one neighboring particle that neighbors a target particle in a space in which a plurality of particles are present. The particle search unit 230 may include a particle information generation unit (not illustrated) and a cell information generation unit (not illustrated).

The particle information generation unit may generate particle reference information about a plurality of particles. The particle information generating unit may secure a memory based on the number of the plurality of particles before generating the particle reference information.

The particle information generation unit may generate particle reference information based on location information of the plurality of particles and cell indexes. The particle reference information may include, for example, particle indexes and a cell indexes including particles corresponding thereto.

FIGS. 3A and 3B are diagrams for describing a process of generating particle reference information. As illustrated in FIG. 3B, the particle information generation unit may secure a memory 310 that may store eight pieces of information corresponding to the number of a plurality of particles, before generating the particle reference information.

Referring to FIG. 3B, the particle information generation unit may generate particle reference information including a particle index 311 and a cell index 312 including a particle corresponding thereto. For example, the particle information generation unit may generate particle reference information including ‘3’, which is a particle index, and ‘7’, which is a cell index including a particle corresponding thereto.

The particle information generation unit may sort the particle reference information in ascending order based on the cell index. Referring to FIG. 3C, the particle information generation unit may sort particle reference information for each of the plurality of particles stored in the memory 310 in ascending order based on the cell index 312 of 0 and 1 or more.

The cell information generation unit may generate cell reference information about a plurality of cells. The cell reference information may include inclusion information and accumulation information.

The cell information generation unit may secure a memory based on the number of the plurality of cells before generating the cell reference information. For example, the cell information generation unit may secure a memory capable of storing information corresponding to the total number of cells. Cell reference information corresponding to one cell may use a memory storing one piece of information.

The cell information generation unit may generate inclusion information based on the cell indexes and the number of particles included in a cell corresponding to each cell index. Referring to FIGS. 3A and 3D, the cell information generation unit may secure a memory capable of storing nine pieces of information, which is the total number of cells. The cell information generation unit may generate inclusion information 321 based on the number of particles included in a cell corresponding to each cell index 320. For example, since there are two particles included in the cell corresponding to cell index 3, the inclusion information may be generated as ‘2’.

The cell information generation unit may generate accumulation information based on the number of particles included in a cell corresponding to a cell index before each cell index. Referring back to FIGS. 3A and 3D, the cell information generation unit may generate accumulation information 322 based on the number of particles included in a cell corresponding to a cell index before each cell index 320. For example, since there is one particle included in a cell corresponding to a cell index before cell index 2, that is, cell index 0, and one particle included in a cell corresponding to cell index 1, accumulation information of cell index 2 may be generated as ‘2’.

The particle search unit 230 may search for at least one neighboring particle that neighbors a target particle based on the particle reference information and the cell reference information. The searching for the neighboring particles may be used to exchange particles among a plurality of processors to be described below. In addition, the searching for the neighboring particles may be used to calculate flow data to be described below.

The particle search unit 230 may search for a neighboring cell based on a cell index corresponding to a cell in which the target particle is located. Referring back to FIG. 3A, for example, with respect to a target particle having a particle index of 1, neighboring cells may be derived as cells corresponding to cell indexes 0, 1, 2, 3, 5, 6, 7 and 8 based on cell index 4 of the cell where the target particle is located.

The particle search unit 230 may search for a neighboring particle based on cell reference information corresponding to the cell in which the target particle is located.

The particle search unit 230 may search for a neighboring particle based on cell reference information corresponding to the neighboring cell. The particle search unit 230 may search for a neighboring particle based on the inclusion information and the accumulated information of the neighboring cell. For example, when a plurality of neighboring cells are derived with respect to the target particle, a neighboring particle may be searched for based on inclusion information and accumulation information of each neighboring cell.

The particle search unit 230 may track a first memory location of the particle reference information corresponding to the neighboring particle based on the accumulation information corresponding to the neighboring cell. The particle search unit 230 may track a plurality of second memory locations of the particle reference information corresponding to the neighboring particle based on the inclusion information corresponding to the neighboring cell.

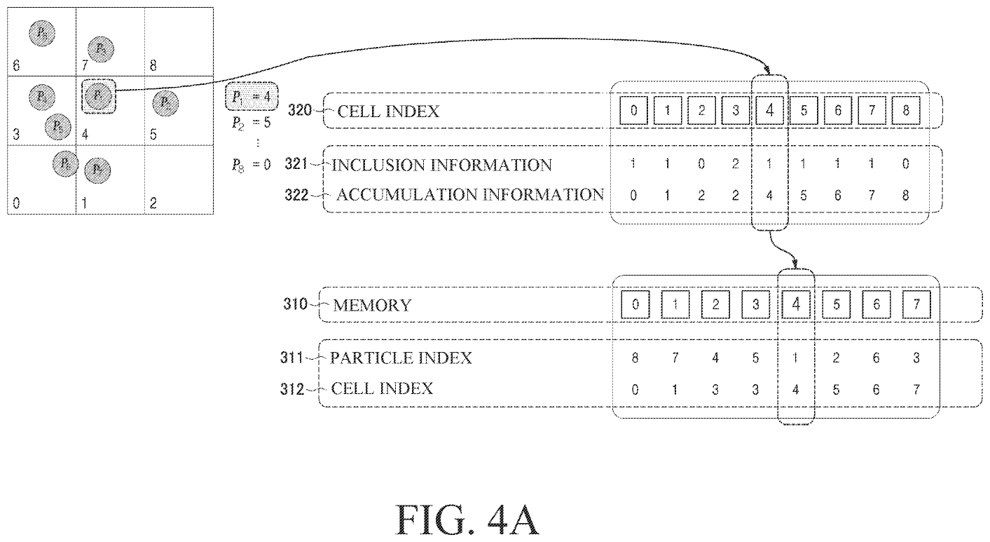

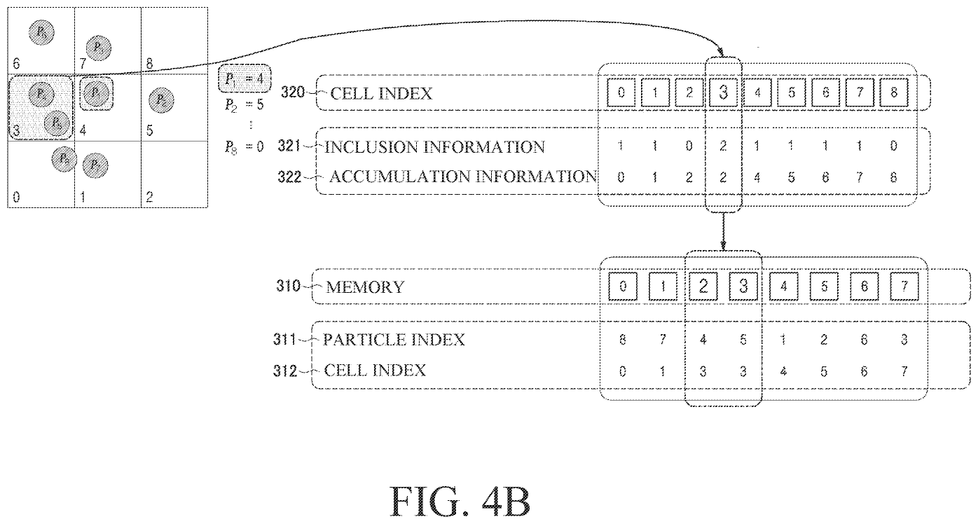

FIG. 4 is a diagram for describing a method of searching for neighboring particles according to an embodiment of the present invention. FIGS. 4A and 4B exemplarily illustrates a process of searching for neighboring particles of a target particle having a particle index of 1. As the method described above, for example, neighboring cells of a target particle having a particle index of 1 may be derived as cells corresponding to cell indexes 0, 1, 2, 3, 5, 6, 7 and 8 based on cell index 4 of the cell where the target particle is located. The particle search unit 230 may search for neighboring particles of the target particle based on corresponding cell reference information with respect to a cell where the target particle is located and each of the derived neighboring cells.

Referring to FIG. 4A, the fluid analysis simulation apparatus 100 may search for neighboring particles in the same cell based on cell reference information corresponding to the cell (cell index 4) in which the target particle is located. The fluid analysis simulation apparatus 100 may extract accumulation information 4 corresponding to a cell having a cell index 4. From this, the fluid analysis simulation apparatus 100 may track that the first memory location of the particle reference information corresponding to the neighboring particle in the same cell is ‘4’.

In addition, the fluid analysis simulation apparatus 100 may extract inclusion information 1 corresponding to a cell having a cell index 4. From this, the fluid analysis simulation apparatus 100 may track the second memory location of the particle reference information corresponding to the neighboring particle in the same cell. The second memory location means a location of a plurality of additional memories that may contain one particle including the particle corresponding to the first memory location. In FIG. 4A, since the inclusion information is ‘1’, only the target particle is located in the cell having cell index 4, and thus the second memory location is not tracked.

Through this, the fluid analysis simulation apparatus 100 may extract particle index 1 included in the cell having cell index 4 based on the tracked first memory location and second memory location. That is, the fluid analysis simulation apparatus 100 may confirm that only a particle included in the neighboring cell having the cell index 4 is itself.

Referring to FIG. 4B, the fluid analysis simulation apparatus 100 may search for neighboring particles in the neighboring cell based on cell reference information corresponding to a cell having a cell index 320 of 3 among the neighboring cells in which the target particle is located. The fluid analysis simulation apparatus 100 may extract accumulation information 2 corresponding to a neighboring cell having a cell index 3. Here, the accumulation information 2 indicates that two particles are present in a plurality of cells corresponding to cell indexes (i.e., cell indexes 0 to 2) before cell index 3. From this, the fluid analysis simulation apparatus 100 may track a first memory location of the particle reference information corresponding to the neighboring particle in the neighboring cell.

That is, the fluid analysis simulation apparatus 100 may check the location (i.e., the first memory location) of memory 2 including information on a third particle present in cell index 3 based on accumulation information 2, and extract particle index 4 of the neighboring particle from memory 2.

In addition, the fluid analysis simulation apparatus 100 may extract inclusion information 2 corresponding to a neighboring cell having cell index 3. Here, inclusion information 2 indicates that two particles are present in cell index 3. From this, the fluid analysis simulation apparatus 100 may track a second memory location of the particle reference information corresponding to the neighboring particle in the neighboring cell. The second memory location means a location of a plurality of additional memories that may contain two particles including the particle corresponding to the first memory location. That is, the fluid analysis simulation apparatus 100 may check the location (i.e., the second memory location) of memory 3 including information on a fourth particle present in cell index 3 based on inclusion information 2, and extract particle index 5 of the neighboring particle from memory 3.

Through this, the fluid analysis simulation apparatus 100 may extract particle indexes 4 and 5 included in the neighboring cell having cell index 3 based on the tracked first memory location and second memory location. That is, the fluid analysis simulation apparatus 100 may confirm that particles included in the neighboring cell having cell index 3 are particles corresponding to particle indexes 4 and 5.

The fluid analysis simulation apparatus 100 may search for all neighboring particles by repeating the above-described process with respect to the cell in which the target particle is located and all cells neighboring thereto, that is, cell indexes 0 to 8.

As described above, the fluid analysis simulation apparatus 100 may utilize inclusion information and accumulation information in searching for neighboring particles of the target particle. That is, the particle reference information is sorted in ascending order based on the cell index, and since the accumulation information is generated based on the number of particles included in the cell corresponding to the cell index before each cell index, the fluid analysis simulation apparatus 100 may easily confirm neighboring particles of the target particle by using the inclusion information and the accumulation information.

More specifically, the fluid analysis simulation apparatus 100 may determine a memory including information of neighboring particles by using inclusion information and accumulation information corresponding to neighboring cells of the cell in which the target particle is located without inquiring all memories including information of the particles in order to search for the neighboring particles of the target particle and may confirm information on neighboring particles by inquiring only the corresponding memory. For this reason, the processing speed of the fluid analysis simulation apparatus 100 may be significantly improved.

The space in which the plurality of particles are present may include a first space and a second space. Referring back to FIG. 1, the fluid analysis simulation apparatus 100 may allocate, for example, the first space to the first processor 110 and the second space to the second processor 120.

As described above, each of the first processor 110 and the second processor 120 may include the space formation unit 220, the particle search unit 230, the particle exchange performance unit 260 and the flow data calculation unit 270.

Accordingly, the space formation unit 220 of the first processor 110 may divide the first space into a plurality of cells, and the cell information generation unit of the first processor 110 may generate first cell reference information based on information on the plurality of cells into which the first space is divided. The particle information generation unit of the first processor 110 may generate first particle reference information based on information on the particles included in the first space.

Similarly, the space formation unit 220 of the second processor 120 may divide the second space into a plurality of cells, and the cell information generation unit of the second processor 120 may generate second cell reference information based on information on the plurality of cells into which the second space is divided. The particle information generation unit of the second processor 120 may generate second particle reference information based on information on the particles included in the second space.

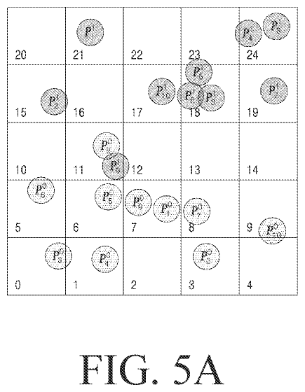

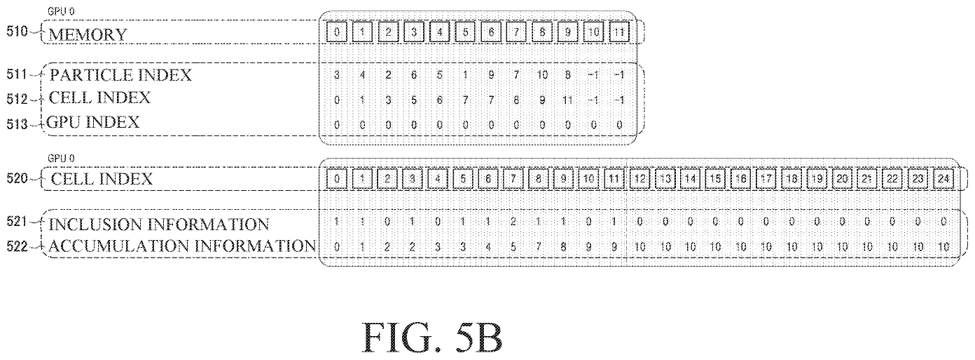

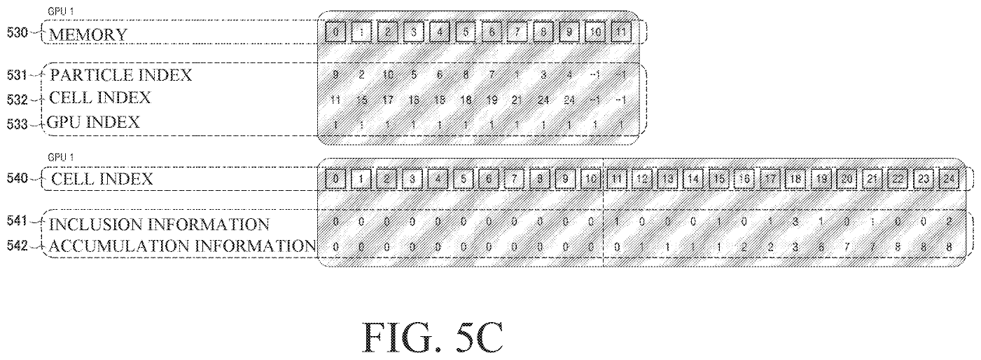

FIG. 5 exemplarily illustrates particle reference information and cell reference information generated by each of a plurality of processors according to an embodiment of the present invention.

Referring to FIGS. 5A and 5B, first cell reference information 520 to 522 generated based on information on cells corresponding to cell indexes 0 to 11 included in the first space by the first processor 110 is illustrated. In addition, first particle reference information 510 to 513 generated based on the information of the particles P⁰₁ to P⁰₁₀ included in the first space by the first processor 110 is illustrated.

Referring to FIGS. 5A and 5C, second cell reference information 540 to 542 generated based on information on cells corresponding to cell indexes 11 to 24 included in the second space by the second processor 120 is illustrated. In addition, second particle reference information 530 to 533 generated based on the information of the particles P¹₁ to P¹₁₀ included in the second space by the second processor 120 is illustrated.

Referring back to FIG. 1, the fluid analysis simulation apparatus 100 may further include a third processor 130. As described above, the third processor 130 may include an input unit 210, a cell management unit 240, and a particle management unit 250.

The cell management unit 240 of the third processor 130 may include an integrated cell information generation unit (not illustrated). The integrated cell information generation unit of the third processor 130 may generate integrated cell reference information based on the first cell reference information and the second cell reference information.

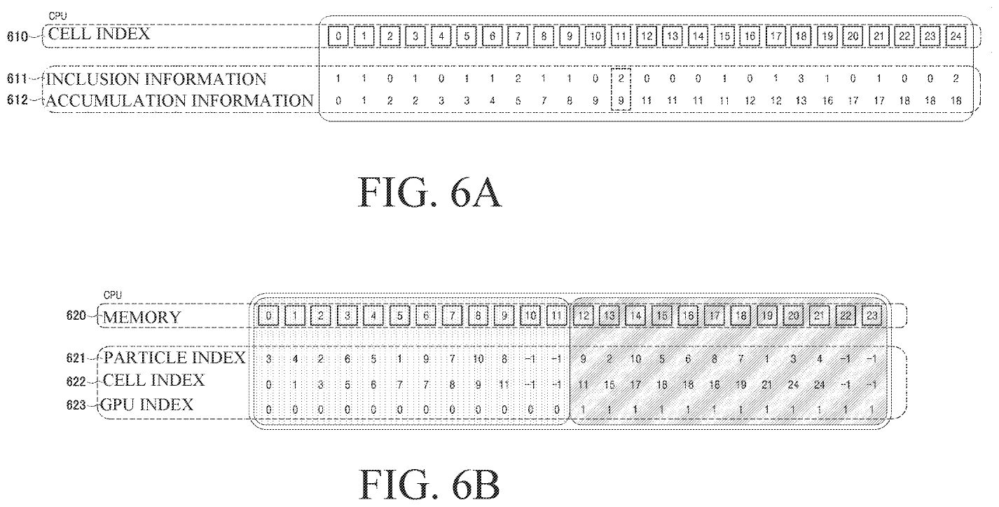

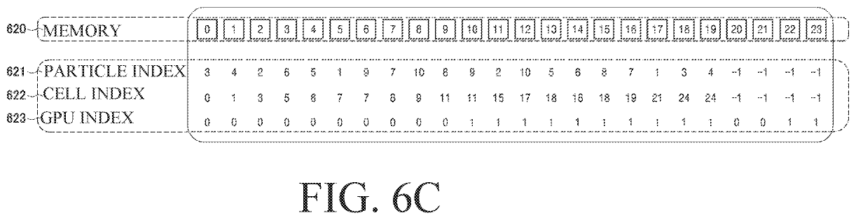

Referring to FIGS. 5A and 6A, the integrated cell information generation unit of the third processor 130 may generate integrated cell reference information 610 to 612 based on the first cell reference information 520 to 522 (FIG. 5B) generated by the first processor 110 and the second cell reference information 540 to 542 (FIG. 5C) generated by the second processor 120. For example, the integrated cell information generating unit of the third processor 130 may generate integrated cell reference information by summing inclusion information of cells corresponding to the same cell index and summing accumulation information of cells corresponding to the same cell index, respectively.

The particle management unit 250 of the third processor 130 may include an integrated particle information generation unit (not illustrated). The integrated particle information generation unit of the third processor 130 may generate integrated particle reference information based on the first particle reference information and the second particle reference information.

Referring to FIGS. 5A and 6B, the integrated particle information generation unit of the third processor 130 may generate integrated particle reference information 620 to 623 based on the first particle reference information 510 to 513 (FIG. 5B) generated by the first processor 110 and the second particle reference information 530 to 533 (FIG. 5C) generated by the second processor 120. For example, the integrated particle information generation unit of the third processor 130 may generate integrated particle reference information by storing the first particle reference information and the second particle reference information in parallel.

The integrated particle information generation unit of the third processor 130 may sort integrated particle reference information in ascending order based on the cell index. Referring to FIG. 6C, the integrated particle information generation unit may sort integrated particle reference information for each of the plurality of particles stored in the memory 620 in ascending order based on the cell index 622 of 0 and 1 or more.

The cell management unit 240 of the third processor 130 may further include an area allocation unit (not illustrated). The area allocation unit of the third processor 130 may derive the number of particles located in the first space and the number of particles located in the second space based on the integrated cell reference information. The area allocation unit of the third processor 130 may allocate the first space to the first processor 110 and allocate the second space to the second processor 120, based on the number of particles located in the first space and the number of particles located in the second space.

Referring back to FIG. 6A, the area allocation unit of the third processor 130 may allocate a space to each processor based on the number of a plurality of particles on the basis of accumulation information 612 of the integrated cell reference information.

The particle management unit 250 of the third processor 130 may further include a particle exchange unit (not illustrated). The particle exchange unit of the third processor 130 may confirm an exchange target particle based on the second cell reference information. That is, the particle exchange unit of the third processor 130 may confirm the exchange target particle based on the space allocated to each processor.

The particle exchange unit of the third processor 130 may extract information on the exchange target particle from the second particle reference information based on the accumulation information of the second cell reference information. The particle exchange unit of the third processor 130 may instruct the movement of the exchange target particle to the first processor based on the information on the exchange target particle.

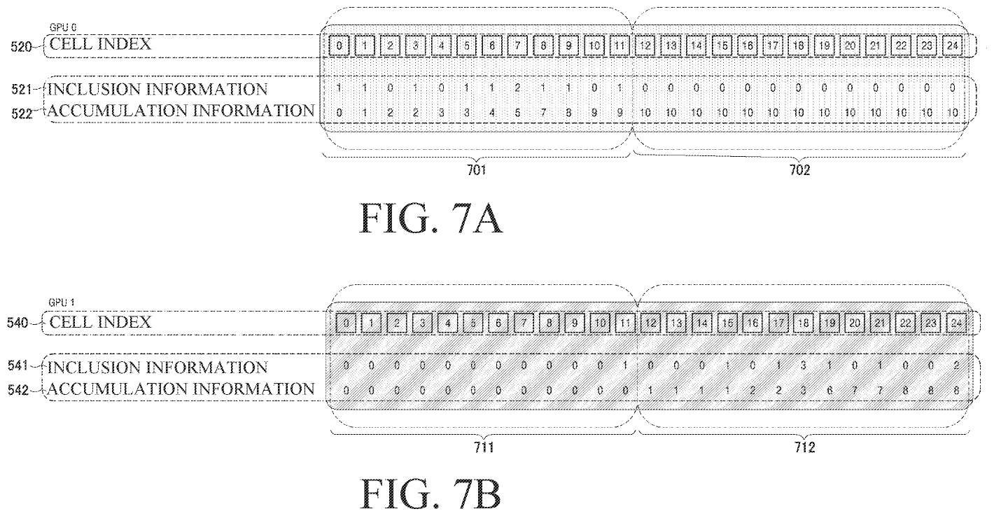

Referring to FIGS. 5B and 7A, the particle exchange unit of the third processor 130 may extract memory information 701 for cells in which non-exchange target particles are present and memory information 702 for cells where exchange target particles are present from the first cell reference information 520 to 522. The particle exchange unit of the third processor 130 may confirm the exchange target particles based on the memory information 701. In this case, the exchange target particle is a particle that is managed by the first processor 110 through the first particle reference information 510 to 513 and a particle that is located in a cell allocated to the second processor 120. FIG. 7A illustrates a case in which exchange target particles are not present.

Referring to FIGS. 5C and 7B, the particle exchange unit of the third processor 130 may extract memory information 711 for cells in which exchange target particles are present and memory information 712 for cells where non-exchange target particles are present from the second cell reference information 540 to 542. The particle exchange unit of the third processor 130 may confirm the exchange target particles based on the memory information 711. In this case, the exchange target particle is a particle that is managed by the second processor 120 through the second particle reference information 530 to 533 and a particle that is located in a cell allocated to the first processor 110. FIG. 7B illustrates a case in which exchange target particles are present in a cell corresponding to cell index 11.

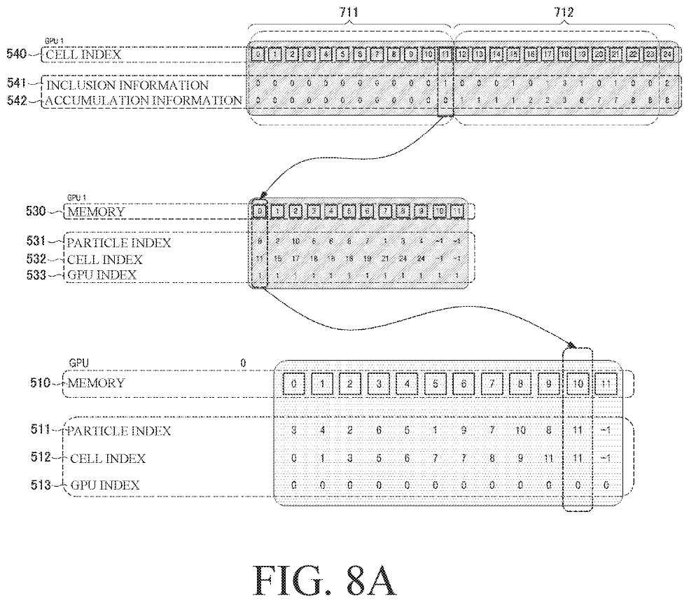

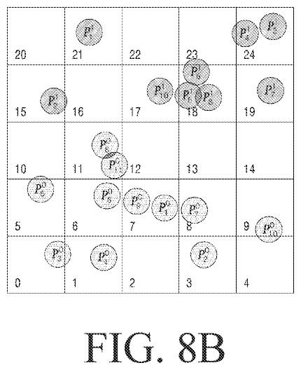

Referring to FIG. 8A, the particle exchange unit of the third processor 130 may track a memory location of the second particle reference information 530 to 533 from the second cell reference information 540 to 542 based on the memory information 711. The particle exchange unit of the third processor 130 may extract particle index 9 of the exchange target particle from the second particle reference information 540 to 542. For example, particle exchange unit of the third processor 130 may track a first memory location of ‘0’ of the second particle reference information 530 to 533 in which the exchange target particles are present from accumulation information ‘0’ corresponding to cell index ‘11’ in which the exchange target particles of the second particle reference information 540 to 542 are present. The particle exchange unit of the third processor 130 may track a second memory location of the second particle reference information 530 to 533 in which the exchange target particles are present from the inclusion information ‘1’ corresponding to cell index ‘11’. In FIG. 8A, since the inclusion information is ‘1’, only the target particle is located in the cell having cell index 11, and thus the second memory location is not tracked.

The particle exchange unit of the third processor 130 may instruct the movement of the exchange target particle to the first processor 110 based on the information on the exchange target particle. For example, the particle exchange unit of the third processor 130 may confirm particle index 9 of the exchange target particle from the memory corresponding to the first memory location of the second particle reference information 530 to 533, and instruct the second processor 120 to move the information about particles corresponding to particle index 9 to the first processor 110.

The particle exchange performance unit 260 of the first processor 110 may receive data about the exchange target particle from the second processor 120.

The particle information generation unit of the first processor 110 may update first particle reference information based on the information on the exchange target particle. The cell information generation unit of the first processor 110 may update first cell reference information based on the information on the exchange target particle.

FIGS. 8A and 8B, the particle information generation unit of the first processor 110 may receives data about a particle corresponding to particle index 9, which is an exchange target particle, from the second processor 120, and update the first particle reference information 510 to 513. The particle information generation unit of the first processor 110 may update the first particle reference information 510 to 513 to include newly assigned particle index 11 for the exchanged particle and cell index 11 of the cell including the exchanged particle. The cell information generation unit of the first processor 110 may update inclusion information and accumulation information of the first cell reference information by including the particle corresponding to particle index 11 in the cell corresponding to cell index 11.

The particle information generation unit of the second processor 120 may update the second particle reference information by deleting a particle corresponding to particle index 9, which is an exchange target particle, from the second particle reference information. The particle information generation unit of the second processor 120 may update inclusion information and accumulation information of the second cell reference information by deleting a particle corresponding to particle index 9, which is an exchange target particle, from the second particle reference information.

The flow data calculation unit 270 may calculate flow data generated due to collision between each particle and neighboring particles or collision between each particle and a polygon constituting a structure model using an SPH algorithm, and perform a fluid analysis simulation based on the flow data.

The SPH algorithm calculates the flow of each particle by using physical property information (e.g., mass, velocity, viscosity, and acceleration) of each particle, and the physical property information of each particle is interpolated using a kernel function set such as a radial-basis function centered on the location of each particle.

When the physical property information of each particle is interposed by the method, continuous fields such as a pressure field and a viscosity field that may be used to calculate the dynamics of a fluid are generated by using a standard equation such as Navier-Stokes equation.

For example, the Navier-Stokes equation models a fluid as follows.

$$p ( ( \frac{\partial v}{\partial t} ) + v \cdot ∇ v ) = ρg - ∇ p + μ {∇}^{2} v \qquad [ Equation 1 ]$$

In Equation 2, “v” represents the velocity of a particles, “ρ” represents the density of the particle, “p” represents the pressure on the particle, “g” represents the gravity, and “μ” represents the viscosity coefficient of the fluid.

Meanwhile, according to the SPH algorithm, the density of each particle is derived by Equation 2.

$$ρ ( {x}_{i} ) = {\sum }_{j} {m}_{j} W ( {x}_{i} - {x}_{j} , h ) \qquad [ Equation 2 ]$$

In addition, a force by the pressure of each particle is derived by Equation 3.

$${f}_{i}^{p r e s s u r e} = - {\sum }_{j} {m}_{j} \frac{{p}_{{i}^{+}} {p}_{j}}{2 {ρ}_{j}} ∇ W ( {x}_{i} - {x}_{j} , h ) \qquad [ Equation 3 ]$$

In addition, a force by the viscosity of each particle is derived by Equation 4.

$${f}_{i}^{ν i s cosity} = μ {\sum }_{j} {m}_{j} \frac{{v}_{j} - {v}_{i}}{{ρ}_{j}} {∇}^{2} W ( {x}_{i} - {x}_{j} , h ) \qquad [ Equation 4 ]$$

The flow data calculation unit 270 calculates change values of the flow data such as density, pressure, viscosity, and the like of each particle by using the SPH algorithm. For example, the flow data calculation unit 270 calculates flow data of each particle at the next time step (second time step) based on initial flow data of each particle, and calculates the flow of each particle based on the calculated flow data.

In addition, the flow data calculation unit 270 calculates flow data of each particle at the next time step based on flow data of each particle in a second time step, and calculates the flow of each particle based on the calculated flow data.

The flow data calculation unit 270 calculates the flow data of each particle at each time step to calculate the flow of each particle, thereby performing the fluid analysis simulation.

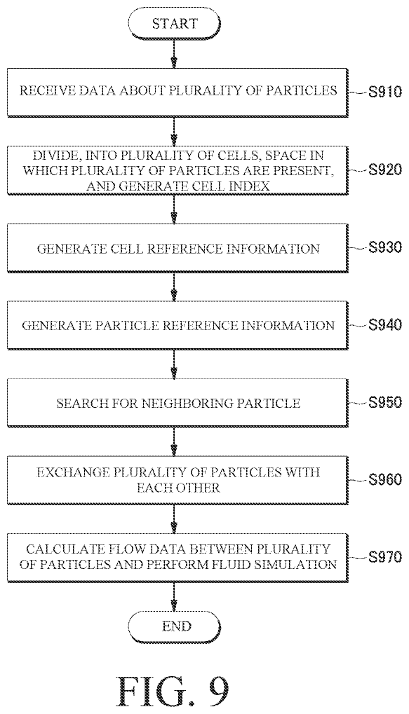

FIG. 9 is a flowchart of a fluid analysis simulation method according to an embodiment of the present invention. A fluid analysis simulation method 900 performed in the fluid analysis simulation apparatus 100 illustrated in FIG. 9 includes steps processed in time series by the fluid analysis simulation apparatus 100 according to the embodiment illustrated in FIG. 2. Accordingly, even if the contents will be omitted below, the present invention is also applied to the method for performing the fluid analysis simulation performed in the fluid analysis simulation apparatus 100 according to the embodiment illustrated in FIG. 2.

In step S920, the fluid analysis simulation apparatus 100 may receive data about a plurality of particles.

In step S920, the fluid analysis simulation apparatus 100 may divide, into a plurality of cells, a space in which the plurality of particles is present and generate cell indexes.

In step S930, the fluid analysis simulation apparatus 100 may generate cell reference information.

In step S940, the fluid analysis simulation apparatus 100 may generate particle reference information.

In step S950, the fluid analysis simulation apparatus 100 may search for neighboring particles.

In step S960, the fluid analysis simulation apparatus 100 may exchange a plurality of particles with each other.

In step S970, the fluid analysis simulation apparatus 100 may calculate flow data between a plurality of particles and perform a fluid simulation.

In the above description, steps S920 to S970 may be further divided into additional steps or may be combined with less steps according to an embodiment of the present invention. In addition, some steps may also be omitted if necessary, or the order between the steps may also be converted.

The method for performing the fluid analysis simulation in the fluid analysis simulation apparatus described with reference to FIGS. 2 to 9 may be implemented even in the form of a recording medium including a computer program stored in a medium executed by a computer or instructions executable by the computer. In addition, the method for performing the fluid analysis simulation in the fluid analysis simulation apparatus described with reference to FIGS. 2 to 9 may be implemented in the form of a computer program stored in a medium executed by a computer.

A computer readable medium may be any available medium accessible by the computer or includes all of volatile and non-volatile media and removable and irremovable media. In addition, the computer readable medium may include computer storage media. The computer storage medium includes all of the volatile and non-volatile and removable and irremovable media implemented by any method or technology for storing information such as a computer readable instruction, a data structure, a program module, or other data.

The aforementioned description of the present invention is used for exemplification, and it can be understood by those skilled in the art that the present invention can be easily modified in other detailed forms without changing the technical spirit or requisite features of the present invention. Therefore, it should be appreciated that the aforementioned embodiments are illustrative in all aspects and are not restricted. For example, respective constituent elements described as single types can be distributed and implemented, and similarly, constituent elements described to be distributed can also be implemented in a coupled form.

The scope of the present invention is represented by claims to be described below rather than the detailed description, and it is to be interpreted that the meaning and scope of the claims and all the changes or modified forms derived from the equivalents thereof come within the scope of the present invention.

What is claimed is:

1. A smoothed-particle hydrodynamics (SPH)-based fluid analysis simulation apparatus comprising:
an input unit receiving data about a plurality of particles for a fluid analysis simulation;
a space formation unit dividing, into a plurality of cells, the space in which the plurality of particles is present, and generating cell indexes based on the locations of the cells in the space where the plurality of particles are present;
a particle search unit searching for at least one neighboring particle that neighbors a target particle, based on particle reference information about the plurality of particles and cell reference information about the plurality of cells; and
a flow data calculation unit calculating flow data between the target particle and the at least one neighboring particle, and performing a fluid simulation based on the flow data for the plurality of particles.

2. The fluid analysis simulation apparatus of claim 1, wherein the particle search unit includes a particle information generation unit generating the particle reference information based on location information of the plurality of particles and the cell indexes; and
a cell information generation unit generating the cell reference information including the cell indexes and inclusion information generated based on the number of particles included in a cell corresponding to each cell index.

3. The fluid analysis simulation apparatus of claim 2, wherein the cell reference information further includes accumulation information generated based on the number of particles included in a cell corresponding to a cell index before each cell index.

4. The fluid analysis simulation apparatus of claim 2, wherein the particle information generation unit sorts the particle reference information in ascending order based on the cell index.

5. The fluid analysis simulation apparatus of claim 3, wherein the particle search unit searches for a neighboring cell based on a cell index corresponding to a cell in which the target particle is located, and searches for the neighboring particle based on the inclusion information and the accumulation information corresponding to the neighboring cell included in the cell reference information.

6. The fluid analysis simulation apparatus of claim 5, wherein the particle search unit tracks a first memory location of the particle reference information corresponding to the neighboring particle based on the accumulation information corresponding to the neighboring cell.

7. The fluid analysis simulation apparatus of claim 6, wherein the particle search unit tracks a plurality of second memory locations of the particle reference information corresponding to the neighboring particle based on the inclusion information corresponding to the neighboring cell.

8. A smoothed-particle hydrodynamics (SPH)-based fluid analysis simulation method comprising:
receiving data about a plurality of particles for a fluid analysis simulation;
dividing, into a plurality of cells, a space in which the plurality of particles is present;
generating a cell index based on the location of the cell in the space in which the plurality of particles is present;
searching for at least one neighboring particle that neighbors a target particle, based on particle reference information about the plurality of particles and cell reference information about the plurality of cells;
calculating flow data between the target particle and the at least one neighboring particle; and
performing a fluid simulation based on the flow data for the plurality of particles.

9. The fluid analysis simulation method of claim 8, wherein the searching for of the neighboring particle includes generating the particle reference information based on the location information of the plurality of particles and the cell index; and generating the cell reference information including the cell index and inclusion information generated based on the number of particles included in the cell corresponding to each cell index.

10. The fluid analysis simulation method of claim 9, wherein the cell reference information further includes accumulation information generated based on the number of particles included in a cell corresponding to a cell index before each cell index.

11. The fluid analysis simulation method of claim 9, wherein the generating of the particle reference information includes sorting the particle reference information in ascending order based on the cell index.

12. The fluid analysis simulation method of claim 10, wherein the searching for of the neighboring particle includes searching for a neighboring cell based on a cell index corresponding to a cell in which the target particle is located; and
searching for the neighboring particle based on the inclusion information and the accumulation information corresponding to the neighboring cell included in the cell reference information.

13. The fluid analysis simulation method of claim 12, wherein the searching for of the neighboring particle includes tracking a first memory location of the particle reference information corresponding to the neighboring particle based on the accumulation information corresponding to the neighboring cell.

14. The fluid analysis simulation method of claim 13, wherein the searching for of the neighboring particle includes tracking a plurality of second memory locations of the particle reference information corresponding to the neighboring particle based on the inclusion information corresponding to the neighboring cell.

15. A computer program stored in a medium including a sequence of instructions of performing a smoothed particle hydrodynamics (SPH)-based fluid analysis simulation, wherein when the computer program is executed by a computing device, the computer program includes a sequence of instructions to receive data about a plurality of particles for a fluid analysis simulation, divide, into a plurality of cells, a space in which the plurality of particles are present, generate a cell index based on the location of the cell in the space in which the plurality of particles are present, search for at least one neighboring particle that neighbors a target particle, based on particle reference information about the plurality of particles and cell reference information about the plurality of cells, calculate flow data between the target particle and the at least one neighboring particle, and perform a fluid simulation based on the flow data for the plurality of particles.
